(19) United States
(12) Patent Application Publication
(10) Pub. No.: US 2022/0200929 A1
(43) Pub. Date: Jun. 23, 2022

(54) MULTI-CLOUD DEPLOYMENT AND VALIDATION

(71) Applicant: CITRIX SYSTEMS, INC., Fort Lauderdale, FL (US)

(72) Inventors: Sindy Giraldo, Deerfield Beach, FL (US); Steven A. Keller, Coral Springs, FL (US)

(21) Appl. No.: 17/127,975

(22) Filed: Dec. 18, 2020

(51) Int. Cl. H04L 12/911; G06F 16/11

(52) U.S. Cl. CPC H04L 47/82; G06F 16/116

(57) ABSTRACT

A method for multi-cloud deployment and validation may be provided. The method may include receiving a first template specifying a cloud resource requirement. A first resource from a first cloud provider and a second resource from a second cloud provider may be identified. The first resource and the second resource may be a same or comparable resource capable of satisfying the cloud resource requirement specified by the first template. The first resource may be selected instead of the second resource based on a respective cost of the first resource and the second resource. A second template for deploying the first resource at the first cloud provider may be generated. The first resource may be deployed by sending the second template to the first cloud provider. Related systems and articles of manufacture are also provided.

### TECHNICAL FIELD

The subject matter described herein relates generally to cloud computing and, more specifically, to deployment and validation across multiple cloud providers.

### BACKGROUND

Cloud computing can include the on-demand availability of a pool of shared computing resources, such as computer networks, server, data storage, software applications, and services, without direct active management by the user. The term “cloud computing” can be generally used to describe data centers available to many users over the Internet. Large clouds often have functions distributed over multiple locations from central servers.

Some cloud computing providers can allow for scalability and elasticity via dynamic (e.g., “on-demand”) provisioning of resources on a fine-grained, self-service basis. This can provide cloud computing users the ability to scale up when the usage need increases or down if resources are not being used.

### SUMMARY

Methods, systems, and articles of manufacture, including computer program products, are provided for multi-cloud deployment and validation. In one aspect, there is provided a system including at least one data processor and at least one memory. The at least one memory may store instructions that result in operations when executed by the at least one data processor. The operations can include: receiving a first template specifying a cloud resource requirement; identifying a first resource from a first cloud provider and a second resource from a second cloud provider, the first resource and the second resource being a same or comparable resource capable of satisfying the cloud resource requirement specified by the first template; selecting, based at least on a respective cost associated with the first resource and the second resource, the first resource instead of the second resource; generating a second template for deploying the first resource at the first cloud provider; and deploying the first resource by at least sending, to the first cloud provider, the second template.

In some variations, one or more of the features disclosed herein including the following features can optionally be included in any feasible combination. The generating of the second template may include modifying the first template or replacing the first template with the second template.

In some variations, the first template and/or the second template may include a TerraForm template, an Azure Resource Manager (ARM) template, a YAML template, and/or a custom template.

In some variations, the first template and/or the second template may include one or more JavaScript Object Notation (JSON) files.

In some variations, the first resource may be selected instead of the second resource based at least on a first cost of the first resource being lower than a second cost of the second resource.

In some variations, a data object including one or more specifications, settings, and/or parameters associated with the first resource may be generated. The second template may be generated based at least on the data object.

In some variations, the first resource and the second resource may be identified based at least on a mapping of comparable resources available from a plurality of cloud providers.

In some variations, the first template may be converted into a markup language file. The first resource and the second resource may be identified, based at least on the markup language file, as satisfying the cloud resource requirement.

In some variations, the markup language file may specify a quantity of required virtual machines, a size of storage, a virtual machine processing capability, and/or a deployed geographic region.

In some variations, the first resource and/or the second resource may include a virtual machine, a storage account, a web application, a database, and/or a virtual network.

In some variations, the first cloud provider and/or the second cloud provider may include an infrastructure as a service (IaaS) platform configured to provide one or more application programming interfaces and pools of hypervisors including virtual machines. The one or more application programming interfaces may enable a provisioning of processing, storage, and/or networks to support an operating system and/or an application.

In another aspect, there is provided a method for multi-cloud deployment and validation. The method may include: receiving a first template specifying a cloud resource requirement; identifying a first resource from a first cloud provider and a second resource from a second cloud provider, the first resource and the second resource being a same or comparable resource capable of satisfying the cloud resource requirement specified by the first template; selecting, based at least on a respective cost associated with the first resource and the second resource, the first resource instead of the second resource; generating a second template for deploying the first resource at the first cloud provider; and deploying the first resource by at least sending, to the first cloud provider, the second template.

In some variations, one or more of the features disclosed herein including the following features can optionally be included in any feasible combination. The generating of the second template may include modifying the first template or replacing the first template with the second template.

In some variations, the first template and/or the second template may include a TerraForm template, an Azure Resource Manager (ARM) template, a YAML template, and/or a custom template.

In some variations, the first template and/or the second template may include one or more JavaScript Object Notation (JSON) files.

In some variations, the first resource may be selected instead of the second resource based at least on a first cost of the first resource being lower than a second cost of the second resource.

In some variations, the method may further include: generating a data object including one or more specifications, settings, and/or parameters associated with the first resource; and generating, based at least on the data object, the second template.

In some variations, the first resource and the second resource may be identified based at least on a mapping of comparable resources available from a plurality of cloud providers.

In some variations, the method may further include: converting the first template into a markup language file; and identifying, based at least on the markup language file, the first resource and the second resource as satisfying the cloud resource requirement, the markup language file specifying a quantity of required virtual machines, a size of storage, a virtual machine processing capability, and/or a deployed geographic region.

In another aspect, there is provided a computer program product that includes a non-transitory computer readable medium. The non-transitory computer readable medium may store instructions that cause operations when executed by at least one data processor. The operations may include: receiving a first template specifying a cloud resource requirement; identifying a first resource from a first cloud provider and a second resource from a second cloud provider, the first resource and the second resource being a same or comparable resource capable of satisfying the cloud resource requirement specified by the first template; selecting, based at least on a respective cost associated with the first resource and the second resource, the first resource instead of the second resource; generating a second template for deploying the first resource at the first cloud provider; and deploying the first resource by at least sending, to the first cloud provider, the second template.

Implementations of the current subject matter can include methods consistent with the descriptions provided herein and articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to multi-cloud deployment and validation, it should be readily understood that such features are not intended to be limiting. The claims that follow this disclosure are intended to define the scope of the protected subject matter.

### DESCRIPTION OF DRAWINGS

FIG. 1 depicts a system diagram illustrating an example of a cloud computing system, in accordance with some example embodiments;

FIG. 2 depicts a data flow diagram illustrating an example data flow for a process for determining a cost estimate for a resource available from multiple cloud providers, in accordance with some example embodiments;

FIG. 3 depicts a data flow diagram illustrating an example data flow for a process for deploying a resource and validating the deployment of the resource, in accordance with some example embodiments;

FIG. 4 depicts a flowchart illustrating an example of a process for multi-cloud deployment and validation, in accordance with some example embodiments;

FIG. 5A depicts a network diagram illustrating an example of a network environment, in accordance with some example embodiments;

FIG. 5B depicts a block diagram illustrating an example of a computing device, in accordance with some example embodiments; and

FIG. 5C depicts a high-level architecture of an example of a virtualization system for implementing a cloud computing system, in accordance with some example embodiments.

When practical, like reference symbols in the various drawings indicate like elements.

### DETAILED DESCRIPTION

Cloud providers can provide a remote computing environment, for example, with virtual machine (VM) infrastructure such as a hypervisor using native execution to share and manage hardware, allowing for multiple cloud computing environments which are isolated from one another, yet exist on the same physical machine. The computing environment can include an infrastructure as a service (IaaS) platform that provides application programming interfaces (APIs) to de-reference low-level details of underlying network infrastructure. In such an infrastructure as a service (IaaS) platform, pools of hypervisors can support large numbers of virtual machines with the ability to scale up and down services to meet varying needs. Infrastructure as a service (IaaS) platforms can provide the capability to the user to provision processing, storage, networks, and other fundamental computing resources where the user is able to deploy and run arbitrary software, which can include operating systems and applications. The user may not manage or control the underlying cloud infrastructure but the user does have control over operating systems, storage, and deployed applications. The user may also have at least some control over one or more select networking components such as host firewalls and/or the like.

Resource costs vary based on utilization of the underlying computing resource such as the required percent of central processing unit (CPU) processing time. Prior to deployment of a resource, such as a virtual machine, storage accounts, web applications, databases, virtual networks, and/or the like, the consumer of the resource can request a quantity of resources for a given time period. For example, the consumer may request a quantity of physical central processing unit for use and a quantity of virtual machines. The cloud provider may then charge a pre-negotiated price for allocating such resources.

A cloud computing organization may provide, to each consumer, resources from multiple cloud providers (e.g., Amazon Web Services (AWS), Microsoft Azure, Google Cloud Platform (GCP), and the like). For example, the cloud computing organization may provide a variety of products, each of which including a variety of resources from multiple cloud providers. That is, to provide a single product to a consumer, the cloud computing organization may deploy or initialize resources from multiple cloud providers. In doing so, the cloud computing organization may incur costs corresponding to the pre-negotiated price for each resource.

To minimize the cost of its offerings, the cloud computing organization may evaluate the cost of same or comparable resources from multiple resources providers. As used herein, the term “same or comparable resources” may refer to two or more resources that may be used interchangeably to satisfy the cloud resource requirements of a consumer of a cloud computing organization. However, the cost associated with resources may be difficult to establish at least because these costs tend to be opaque, variable, and subject to frequent fluctuations. For example, when a same or comparable resource is available from multiple cloud providers, the cost of the resource may vary based on the deployment mechanism (e.g., as defined in a deployment template) and the individually negotiated rate associated with each cloud provider. The extraction and comparison of pricing data for the same or comparable resource from different cloud providers may be a complex endeavor. Using deployment templates, such as TerraForm, Azure Resource Manager (ARM), YAML, and/or the like, to deploy resources may further obscure the corresponding pricing data. These challenges may prevent the cloud computing organization from determining the cost of various resources and thwart efforts to minimize the cost of its offerings.

In some example embodiments, a cost engine may be configured to determine, prior to deploying a resource, a cost estimate for the resource. The cost estimate for the resource may include the expected cost of the resource for one or more deployment mechanisms (e.g., deployment templates and/or the like). Moreover, the cost estimate for the resource may include the expected cost of the resource from one or more cloud providers (e.g., Amazon Web Services (AWS), Microsoft Azure, Google Cloud Platform (GCP), and/or the like). As used herein, a “resource” may refer to any manageable item available from a cloud provider. Examples of a resource may include a virtual machine, a storage account, a web application, a database, a virtual network, and/or the like.

In some example embodiments, the cost engine may select, based at least on the cost estimate associated with the resource, a cloud provider for providing the resource. For example, if a same or comparable resource is available from multiple cloud providers, the cost engine may select a cloud provider providing the resource at a lowest cost. Moreover, a deployment controller may deploy the resource from the selected cloud provider. For instance, in order to deploy the resource from the selected cloud provider, the deployment controller may generate a deployment template (e.g., TerraForm, Azure Resource Manager (ARM), YAML, and/or the like) compatible with the selected cloud provider.

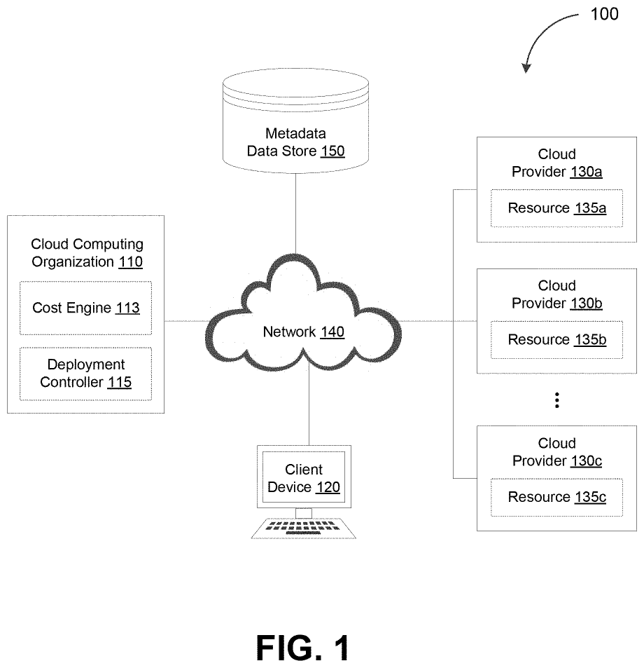

FIG. 1 depicts a system diagram illustrating an example of a cloud computing system 100, in accordance with some example embodiments. Referring to claim 1, the cloud computing system 100 includes a cloud computing organization 110, one or more client devices 120, and one or more cloud providers 130. As shown in FIG. 1, the cloud computing organization 110, the client devices 120, and the one or more cloud providers 130 may be communicatively coupled via a network 140. The network 140 may be a wired network and/or a wireless network including, for example, a local area network (LAN), a virtual local area network (VLAN), a wide area network (WAN), a public land mobile network (PLMN), the Internet, and/or the like. The client devices 120 may be a processor-based device including, for example, a smartphone, a personal computer, a tablet computer, a wearable apparatus, an Internet-of-Things (IoT) appliance, and/or the like.

Referring again to FIG. 1, the one or more cloud providers 130 may provide the same or comparable resources 135. For example, as shown in FIG. 1, a first cloud provider 130a may provide a first resource 135a, a second cloud provider 130b may provide a second resource 135b, and a third cloud provider 130c may provide a third resource 135c. Each of the first cloud provider 130a, the second cloud provider 130b, and the third cloud provider 130c may include an infrastructure as a service platform configured to provide application programming interfaces and supporting pools of hypervisors including virtual machines. These application programming interfaces may enable the provision of processing, storage, and/or networks to support various operating systems and/or applications.

Because the first resource 135a, the second resource 135b, and the third resource 135c constitute the same or comparable resource 135, the cloud computing organization 110 may provide, to a consumer, any one of the first resource 135a, the second resource 135b, and the third resource 135c. That is, one or more cloud resource requirements of consumer may be met by the cloud computing organization 110 deploying any one of the first resource 135a, the second resource 135b, and the third resource 135c. Accordingly, the cloud computing organization 110 may provide one or more products including the first resource 135a from the first cloud provider 130a, the second resource 135b from the second cloud provider 130b, or the third resource 135c from the third cloud provider 130c.

In providing the resource 135 from the one or more cloud providers 130, the cloud computing organization 110 may incur costs corresponding to the pre-negotiated price for each of the one or more resources 135. As such, although the first resource 135a, the second resource 135b, and the third resource 135c constitute the same resource and/or comparable resource 135, the cloud computing organization 110 may nevertheless incur a different cost when deploying a different one of the first resource 135a, the second resource 135b, and the third resource 135c. For example, the cloud computing organization 110 may incur less cost when deploying the first resource 135a than when deploying the second resource 135b or the third resource 135c. To minimize cost and in turn increase revenue and/or profit, the cloud computing system organization 110 may deploy the first resource 135a instead of the second resource 135b or the third resource 135c.

The cost associated with the resource 135 may be difficult to establish at least because such costs tend to be opaque, variable, and subject to frequent fluctuations. For example, the cost of the first resource 135a, the second resource 135b, and the third resource 135c may vary based on deployment mechanism (e.g., as defined in a deployment template) and the individually negotiated rate associated with each of the cloud providers 130. The extraction and comparison of pricing data for the first resource 135a, the second resource 135b, and the third resource 135c may be a complex endeavor. Moreover, using deployment templates, such as TerraForm, Azure Resource Manager (ARM), YAML, and/or the like, may further obscure pricing data. These challenges may prevent the cloud computing organization 110 from determining the cost of the resource 135 and thwart efforts to minimize the cost incurred by the cloud computing organization 110.

In some example embodiments, the cloud computing organization 110 may include a cost engine 113 and a deployment controller 115. The cost engine 113 may be configured to determine, prior to deploying the resource 135, a cost estimate for the resource 135. The cost estimate for the resource 135 may include the expected cost of the resource 135 for one or more deployment mechanisms (e.g., deployment templates and/or the like). Moreover, the cost estimate for the resource 135 may include the expected cost of the resource from one or more cloud providers (e.g., Amazon Web Services (AWS), Microsoft Azure, Google Cloud Platform (GCP), and/or the like). For example, as shown in FIG. 1, the cost estimate for the resource 135 may include a first cost of the first resource 135a from the first cloud provider 130a, a second cost of the second resource 135b from the second cloud provider 130b, and a third cost of the third resource 135c from the third cloud provider 130c.

The cost engine 113 may select, based at least on the cost estimate associated with the resource 135, one of the cloud providers 130 for providing the resource 135. For example, the cost engine 113 may select one of the cloud providers 130 providing the resource 135 at a lowest cost. Moreover, the deployment controller 115 may deploy the resource 135 from the selected one of the cloud providers 130. For instance, in order to deploy the resource 135 from the selected one of the cloud providers 130, the deployment controller 115 may generate a deployment template (e.g., TerraForm, Azure Resource Manager (ARM), YAML, and/or the like) compatible with the selected one of the cloud providers 130.

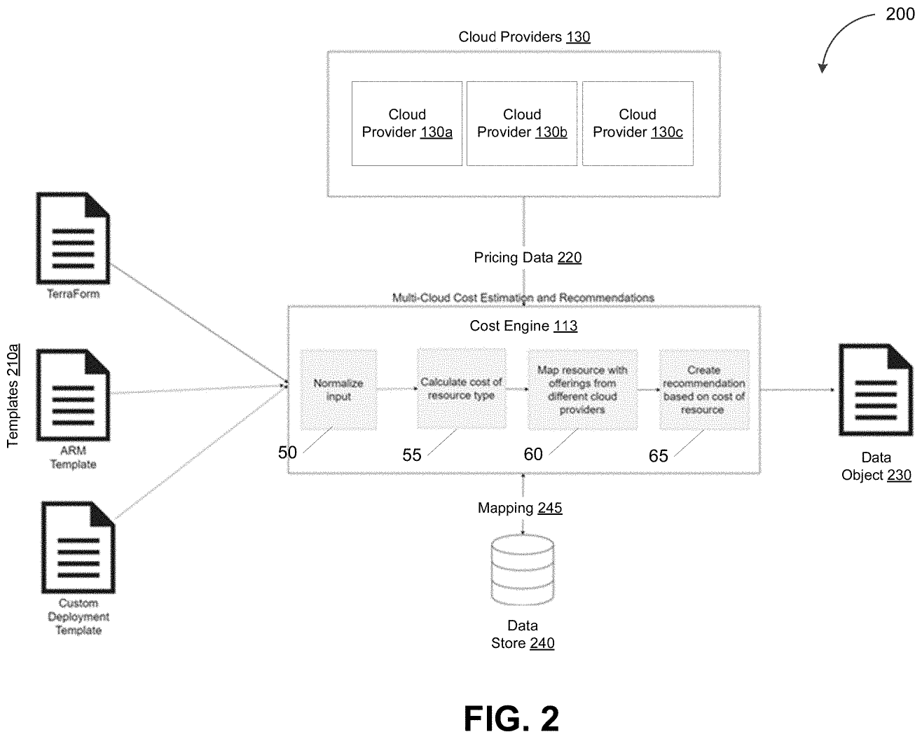

FIG. 2 depicts a data flow diagram illustrating an example data flow 200 for a process for determining a cost estimate for a resource available from multiple cloud providers, in accordance with some example embodiments. Referring to FIGS. 1-2, the cost engine 113 may receive, for example, from the client devices 120, one or more deployment mechanisms, each of which may be a deployment template characterizing the requirements for the resources deployed from a cloud provider. For example, as shown in FIG. 2, the one or more deployment mechanisms may include one or more first templates 210 (e.g., a TerraForm template, an Azure Resource Manager (ARM) template, a custom deployment template, and/or the like). The one or more first templates 210 may be generated using an infrastructure as code tool (e.g., TerraForm, AWS Cloud Formation, and/or the like), which may be configured to support the creation, updating, and versioning of various resources. Moreover, the one or more first templates 210 may include one or more JavaScript Object Notation (JSON) files in which the objects, types, names, and/or properties of the desired resources are declared. It should be appreciated that these JavaScript Object Notation (JSON) files may be checked into source control and managed like any other code file.

To further illustrate, Table 1 depicts a portion of an example a template file (e.g., an Azure Resource Manager (ARM) template file) relating to the definition and/or deployment of one or more resources.

```
TABLE 1
  ″resources″: [
    {
      ″condition″: ″<true-to-deploy-this-resource>″,
      ″type″: ″<resource-provider-namespace/resource-type-name>″,
      ″apiVersion″: ″<api-version-of-resource>″,
      ″name″: ″<name-of-the-resource>″,
      ″comments″: ″<your-reference-notes>″,
      ″location″: ″<location-of-resource>″,
      ″dependsOn″: [
        ″<array-of-related-resource-names>″
      ],
      ″tags″: {
        ″<tag-name1>″: ″<tag-value1>″,
        ″<tag-name2>″: ″<tag-va1ue2>″
      },
      ″sku″: {
        ″name″: ″<sku-name>″,
        ″tier″: ″<sku-tier>″,
        ″size″: ″<sku-size>″,
        ″family″: ″<sku-family>″,
        ″capacity″: <sku-capacity>
      },
      ″kind″: ″<type-of-resource>″,
      ″copy″: {
      ″name″: ″<name-of-copy-loop>″,
      ″count″: <number-of-iterations>,
      ″mode″: ″<serial-or-parallel>″,
      ″batchSize″: <number-to-deploy-serially>
    },
    ″plan″: {
      ″name″: ″<plan-name>″,
      ″promotionCode″: ″<plan-promotion-code>″,
      ″publisher″: ″<plan-publisher>″,
      ″product″: ″<plan-product>″,
      ″version″: ″<plan-version>″
    },
    ″properties″: {
      ″<settings-for-the-resource>″,
      ″copy″: [
        {
          ″name″: ,
          ″count″: ,
          ″input″: { }
        }
      ]
    },
    ″resources″: [
      ″<array-of-child-resources>″
    ]
  }
]
```

Referring again to FIG. 2, the cost engine 113 may also receive, from the resource providers 130, a pricing data 220. As noted, the resource providers 130 may include the first cloud provider 135a (e.g., Amazon Web Services (AWS)), the second cloud provider 135b (e.g., Azure), and the third cloud provider 135c (e.g., Google Cloud Platform (GCP)) providing the same or comparable resource 135. It should be appreciated that the resource providers 130 may be any remote computing platform that is capable of providing computing resources (e.g., a virtual machine, storage accounts, web applications, databases, virtual networks, and/or the like) on-demand and without direct and/or active management by a consumer of the resource. The pricing data 220 may include a cost associated with each one of the resources 135 and the corresponding resource type and/or capabilities.

The pricing data 220 may be dynamically calculated based on the account pricing list associated with a specific consumer (or other entity). For example, the cost estimate for the resource 135 may be specific for a given account, which may have negotiated rates different from those associated with other accounts and special discounts and reserved instances and/or capacities. Accordingly, in some example embodiments, the cost engine 113 may retrieve the pricing data 220 via an application programing interface (API) associated with each one of the cloud providers 130. Examples of these application programming interfaces may include a representational state transfer (REST) API, Microsoft Azure's Enterprise APIs (e.g., including reporting APIs, consumption APIs, and helper APIs), Amazon Web Services (AWS) Athena, and Google Cloud's cloud billing APIs.

The account information may include a cloud-based identity and can relate to an access management service of the one or more cloud providers 130. The account information may include information that enables consumers of each cloud provider 130 (e.g., information technology (IT) administrators, application developers, etc.) to access the cloud providers 130 and the corresponding resources 135. For example, the account information may relate to a user with a username and password, applications, or other servers that require authentication through secret keys, certificates, and/or the like.

The cost engine 113 may also receive, for example, from a data store 240, a mapping 245 of the same or comparable resources 135 available from the cloud providers 130. For example, the mapping 245 may include a mapping from one or more cloud resource requirements to the first resource 135a, the second resource 135b, and the third resource 135c in order to indicate that the first resource 135a, the second resource 135b, and the third resource 135c may be deployed interchangeably to satisfy the cloud resource requirements of a consumer. That is, either one of the first resource 135a, the second resource 135b, and the third resource 135c may be deployed to satisfy the cloud resource requirements of the consumer.

In some example embodiments, the mapping 245 may identify the same or comparable resource 135 (e.g., the first resource 135a, the second resource 135b, and the third resource 135c) and other equivalent products (e.g., resource types, resources names, and/or the like) offered by the cloud providers 130. Alternatively and/or additionally, the mapping 245 may identify nonequivalent products such as, for example, a resource (e.g., a given virtual machine type) that may not be identical when deployed on a different one of the first cloud provider 130a, the second cloud provider 130b, and the third cloud provider 130c. It should be appreciated that the mapping 245 of resources available from different cloud providers may enable a more direct cost comparison between the same or comparable resources. Moreover, the mapping 245 may be subject to updates based on changes to the corresponding pricing data 220 which, as noted, may include the cost and the type and capabilities of the resources 135 available from the cloud providers 130.

Table 2 depicts an example of a class definition for the mapping 245 of the same or comparable resources available from multiple cloud providers. As shown in Table 2, a dictionary may be used with a main key being the resource category, which may encompass resources of different types from different cloud providers. Selecting an element from the dictionary matching a resource category may result in a list of same or comparable resources (e.g., the first resource 135a, the second resource 135b, the third resource 135c, and/or the like).

```
TABLE 2
          classCloudResource
          {
          string CloudProvider {get; set; }
          string OS {get; set; }
          string  ResourceCategory  {get; set; }
string  CloudResourceDefinition  {get;  set;  }
string Region {get; set; }
            string Capabilities {get; set; }
          }
          Dictionary<string, List<CloudResource>>
cloudResourceDictionary = new  Dictionary
{
  {
    “VM”,  new  CloudResourceMap  0
      {
        “Azure”,
        “Windows”,
        “VM,”
            “D2 v3”,
            “EastUs”,
            “Cpu:2,  RAM:8GB,DISK:50GB”
    }
  },
  “VM”,  new  CloudResourceMap  0
    {
      “AWS”,
          “Windows”,
      “VM”,
          “t3a.large”,
          “EastUs”,
          “Cpu:2,  RAM:8GB,DISK:50GB”
    }
  },
}
```

In some example embodiments, cost may be omitted from the mapping 245 because cost (e.g., the pre-negotiated rate associated with each cloud provider 130) may be subject to frequent changes. Instead, the mapping 245 may be used to identify, for example, the first resource 135a, the second resource 135b, and the third resource 135c as the same or comparable resource 135 before the pricing data 220 is obtained from the corresponding cloud providers 130. Alternatively and/or additionally, cost may be included in the mapping 245, in which case the mapping 245 may be updated periodically in order to capture changes to the cost of each resource.

Referring again to FIG. 2, the cost engine 113 may, as indicated at 50, normalize the one or more first templates 210 and/or the pricing data 220. Normalizing the one or more first templates 210 may include, for example, processing and/or converting the templates 210 to a markup language file (e.g., extensible markup language (XML) and/or the like). For example, the one or more first templates 210 may be converted into a markup language file with fields specifying a quantity of required virtual machines, a size of storage, a virtual machine processing capability, a deployed geographic region, and/or the like. Other example fields may also be possible and may correlate to other resource types.

The cost engine 113 may predict, based on the one or more first templates 210 and/or the pricing data 220, the costs associated with deploying one or more resources (e.g., the resource 135) that satisfy the cloud resource requirements (e.g., specified in the one or more first templates 210) within each one of the cloud providers 130. As indicated at 55, this predicting may include calculating the cost associated with various types of resources. For example, the cost estimate for the resource 135 may be calculated based on a pre-negotiated price, available discounts, reserved capacities and instances, and/or the like. The estimating may be performed, for example, using the fields within the markup language file to determine which types of resources from the different cloud providers 130 satisfy one or more of the cloud resource requirements set forth in each of the one or more first templates 210. Utilizing user specific account information may enable a more accurate cost estimation for each resource.

In some example embodiments, the cost engine 113 may determine, for each one of the cloud providers 130, one or more available resources that satisfy the cloud resource requirements specified in the templates one or more first templates 210. For example, these resources the same or comparable resource 135 from the cloud providers 130 including, as noted, the first resource 135a from the first cloud provider 130a, the second resource 135b from the second cloud provider 130b, and the third resource 135c from the third cloud provider 130c. Nevertheless, it should be appreciated that the specific type and/or types of resources that satisfy the cloud resource requirements set forth in the one or more first templates 210 may vary between the first cloud provider 130a, the second cloud provider 130b, and the third cloud provider 130c.

Referring again to FIG. 2, as indicated at 60, the cost engine 113 may determine a cost estimate for the resource 135 by identifying, based at least on the mapping 245, the first resource 135a from the first cloud provider 130a, the second resource 135b from the second cloud provider 130b, and the third resource 135c from the third cloud provider 130c as the same or comparable resource 135. The mapping 245 from the database 240 may, as noted, identify the same or comparable resources available from multiple cloud providers such that the various costs of the same or comparable resource 135 may be determined. Doing so may enable a more accurate cost calculation and comparison as between the cloud providers 130 such that the cost engine 113 may identify the one of the cloud providers 130 providing the resource 135 at a lowest cost.

As indicated at 65, the cost engine 113 may select, based at least on the cost estimate associated with the resource 135, one of the cloud providers 130 for providing the resource 135. For instance, as noted, the cost estimate for the resource 135 may include the first cost of the first resource 135a from the first cloud provider 130a, the second cost of the second resource 135b from the second cloud provider 130b, and the third cost of the third resource 135c from the third cloud provider 130c. Accordingly, the cost engine 113 may select, based least on the first cost of the first resource 135a being lower than the second cost of the second resource 135b and the third cost of the third resource 135c, the first cloud provider 130a to provide the first resource 135a.

As shown in FIG. 2, the cost engine 113 may generate a recommendation that includes, for example, the first cloud provider 130a selected to provide the first resource 135a. This recommendation may include one or more specifications, settings, and/or parameters of the resources to utilize from the first cloud provider 130a. For example, the recommendation may specify at least the first resource 135a from the first cloud provider 130a and the corresponding parameters (e.g., Cpu:2, RAM:8GB,DISK:50GB). As shown in FIG. 2, the recommendation may be included in a data object 230 output by the cost engine 113. For instance, the data object 230 may be a JavaScript Object Notation (JSON) file that includes one or more fields characterizing the cost estimate associated with the resource 135 and the recommendation to deploy the first resource 135a from the first cloud provider 130a. The data object 230 may be inserted into a pre-deployment state of a resource manager template, for example a pre-deployment template (e.g., the one or more first templates 210). Doing so may enable the modified template to be subject to further processing, modification, and refinement, for example, via an infrastructure as code tool (e.g., TerraForm, AWS CloudFormation, and/or the like).

Deployment of one or more resources including, for example, the first resource 135a from the first cloud provider 130a, may be performed in accordance with a corresponding one of the first templates 210. The first resource 135a, for example, a collection of virtual machines, may be deployed at the first cloud provider 130a such that the first resource 135a executes application code on physical hardware managed by the first cloud provider 130a. The first cloud provider 130a may provide a configuration of computing resources for executing the first resource 135a in accordance to the corresponding one of the first templates 210. For instance, the first cloud provider 130a may allocate a certain pre-agreed quantity of computing resources (e.g., number of virtual machines, percentage of central processing unit time, disk storage size, and/or the like) to the first resource 135a to support operation of the first resource 135a within the computing environment of the first cloud providers 130a.

In some example embodiments, the deployment may be achieved based on the data object 230 output by the cost engine 113 and/or one of the first templates 210. It should be appreciated that following recommendations set forth in the data object 230 may result in the deployment of the first resource 135a from the first cloud provider 130a, which meets the cloud resource requirements of the consumer but at a lower cost than the other available resources such as the second resource 135b from the second cloud provider 130a and the third resource 135c from the third cloud provider 130c.

In some example embodiments, the data object 230 (e.g., the JavaScript Object Notation (JSON) file) may include a collection of resource objects, as described previously, for the selected resources such as the first resource 135a from the first cloud provider 130a. Ordering and grouping within the data object 230 may vary across implementations. For example, ordering and grouping may be chosen to group resources by category, keep in order to better correlate to the input file, and/or the like. The output may be used for various processes and may form a report to guide a consumer seeking a cost recommendation. To further illustrate, Table 3 below depicts an example of a JavaScript Objection Notation (JSON) file.

```
TABLE 3
        {
        ResourceRecommendations”: [
        {
      “Azure”,
      “Windows”,
      “VM”,
              “D2 v3”,
              “EastUs”,
              “Cpu:2,  RAM:8GB,DISK:50GB”
    }
},
        ]
      }
```

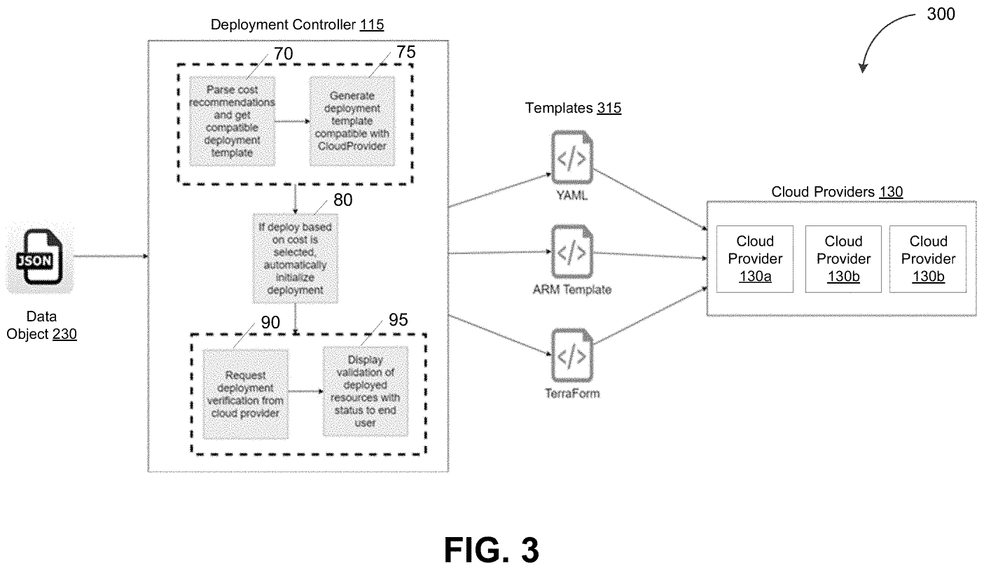

FIG. 3 depicts a data flow diagram illustrating an example data flow 300 for a process for deploying a resource and validating the deployment of the resource, in accordance with some example embodiments. In some example embodiments, the deployment controller 115 may deploy the resource 135 from the selected one of the cloud providers 130. For example, the first resource 135a from the first cloud provider 130a may be selected based at least on the first cost of the first resource 135a being lower than the respective costs of the same or comparable second resource 135b and the third resource 135c. In order to deploy the first resource 135a from the first cloud provider 130a, the deployment controller 115 may generate a deployment template (e.g., TerraForm, Azure Resource Manager (ARM), YAML, and/or the like) compatible with the first cloud provider 130a.

To further illustrate, FIG. 3 shows that the deployment controller 115 may deploy, based at least on the data object 230 (e.g., the JavaScript Object Notation (JSON) file) output by the cost engine 113, the first resource 135a from the first cloud provider 130a. For example, as shown in FIG. 3, the deployment controller 115 may receive, from the cost engine 113, on the data object 230 (e.g., the JavaScript Object Notation (JSON) file) including the cost estimate associated with the resource 135 and the recommendation to deploy the first resource 135a from the first cloud provider 130a. As indicated at 70, the deployment controller 115 may parse the data object 230, for example, the recommendation included in the data object 230, and retrieve a deployment template that is compatible with the first cloud provider 130a. At 75, the deployment controller 115 may generate a deployment template compatible with the first cloud provider 130a. For instance, as shown in FIG. 3, the deployment controller 115 may generate, based at least on a compatibility with the first cloud provider 130a, one or more second templates 315.

The one or more second templates 315 may include one or more JavaScript Object Notation (JSON) files in which the objects, types, names, and/or properties of the desired resources (e.g., the first resource 135a) are declared. Moreover, in some example embodiments, the one or more second templates 315 may replace the one or more first templates 210. Alternatively and/or additionally, the one or more second templates 315 may be generated by modifying the one or more first templates 210.

As indicated at 80, the deployment controller 115 may initialize the deployment of the first resource 135a at the first cloud provider 130a. In some example embodiments, the deployment controller 115 may initialize the deployment of the first resource 135a automatically or upon further request, for example, by a user at the client devices 120. For example, if the deployment is configured to be automatic (e.g., deployment based on cost), the deployment controller 115 may deploy the first resource 135a without requiring a corresponding request or command from the user at the client devices 120. Alternatively, if the deployment is not set to be automatic, the deployment controller 115 may initiate the deployment of the first resource 135a upon receiving, from the user at the client devices 120, a request or command to do so. In the meantime, the deployment controller 115 may send, to the client devices 120, the one or more second templates 310 for deploying the first resource 135a for review and/or approval.

The deployment of the first resource 135a at the first cloud provider 130a may be performed based on a compatible template. For instance, the deployment controller 115 may deploy the first resource 135a by at least sending, to the first cloud provider 130a, a corresponding one of the second templates 315. In instances where the cloud resource requirements of the consumer require the deployment of resources from additional cloud providers, such as the second cloud provider 130b and/or the third cloud provider 130c, the deployment controller 115 may deploy those resources by generating and sending, to the corresponding cloud providers, compatible templates configured to deploy the resources.

Referring again to FIG. 3, in some example embodiments, the deployment controller 115 may validate and monitor a status of the deployment of the first resource 135a at the first cloud provider 130a. For example, as indicated at 90, the deployment controller 115 may request, from the first cloud provider 130a, a status of the deployment including a verification that the first resource 135a has been deployed at the first cloud provider 130a. Moreover, at 95, the deployment controller 115 may provide, to the consumer, an output indicating a status of the deployment of the first resource 135a. For instance, the deployment controller 115 may generate a user interface (e.g., a graphic user interface (GUI) and/or the like) configured to display, at the client devices 120, the status of the deployment including a verification that the first resource 135a has been deployed at the first cloud provider 130a.

In some example embodiments, the subject matter described herein may provide technical advantages. For example, the current subject matter may provide insight into the cost of goods associated with various cloud resources, particularly when the same or comparable resources are available from multiple cloud providers. This insight may be applied towards cost reduction and revenue and profit maximization. In addition, the subject matter described herein may streamline the deployment of cloud resources, particularly a selection of cloud resources that minimizes the cost of goods.

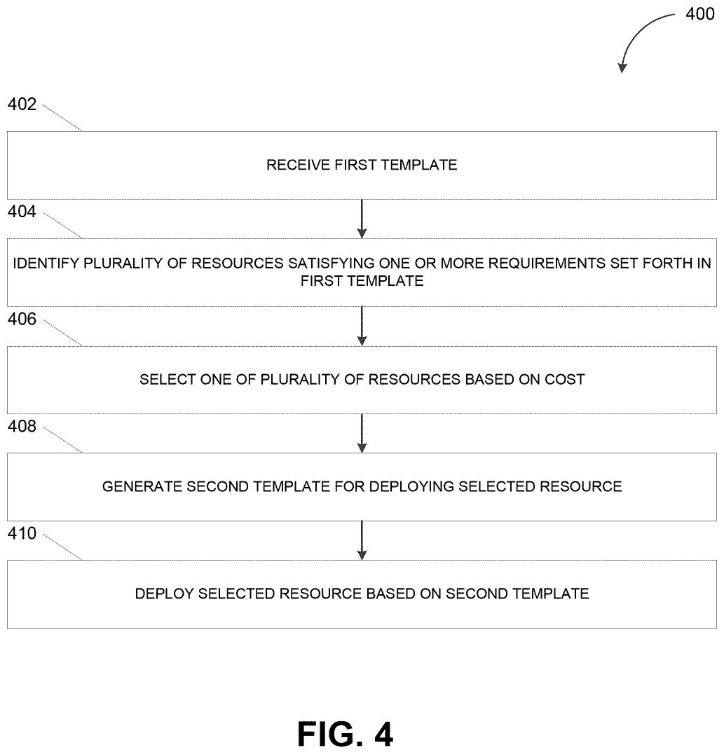

FIG. 4 depicts a flowchart illustrating an example of a process 400 for multi-cloud deployment and validation, in accordance with some example embodiments. Referring to FIGS. 1-4, the process 400 may be performed at the cloud computing organization 100, for example, by the cost engine 113 and the deployment controller 115.

At 402, a first template may be received. For example, the cost engine 113 may receive the one or more first templates 210 (e.g., a TerrForm template, an Azure Resource Manager (ARM) template, a custom deployment template, and/or the like). The one or more first templates 210 may specify the requirements for one or more cloud-based resources. For instance, the one or more first templates 210 may include one or more JavaScript Object Notation (JSON) files with declarations for the objects, types, names, and/or properties of the desired resources.

At 404, a plurality of resources satisfying one or more requirements set forth in the first template may be identified. In some example embodiments, the mapping 245 from the database 240 may identify the same or comparable resources available from multiple cloud providers. For example, the mapping 245 may include a mapping from one or more cloud resource requirements to the first resource 135a, the second resource 135b, and the third resource 135c in order to indicate that the first resource 135a, the second resource 135b, and the third resource 135c may be deployed interchangeably to satisfy the cloud resource requirements of a consumer. Accordingly, the cost engine 113 may identify, based at least on the mapping 245, the first resource 135a from the first cloud provider 130a, the second resource 135b from the second cloud provider 130b, and the third resource 135c from the third cloud provider 130c as the same or comparable resource 135 capable of satisfying the cloud resource requirements of the consumer.

At 406, one of the plurality of resources may be selected based at least on a cost associated with each of the plurality of resources. In some example embodiments, the cost engine 113 may select, based at least on the cost estimate associated with the resource 135, one of the cloud providers 130 for providing the resource 135. For example, the cost estimate for the resource 135 may include the first cost of the first resource 135a from the first cloud provider 130a, the second cost of the second resource 135b from the second cloud provider 130b, and the third cost of the third resource 135c from the third cloud provider 130c. Accordingly, the cost engine 113 may select, based least on the first cost of the first resource 135a being lower than the second cost of the second resource 135b and the third cost of the third resource 135c, the first cloud provider 130a to provide the first resource 135a. Moreover, the cost engine 113 may generate and output (e.g., as the data object 230) a recommendation that includes, for example, one or more specifications, settings, and/or parameters of the first resource 135a from the first cloud provider 130a. For instance, the recommendation may specify at least the first resource 135a from the first cloud provider 130a and the corresponding parameters (e.g., Cpu:2, RAM:8GB,DISK:50GB).

At 408, a second template for deploying the selected resource may be generated. In some example embodiments, the deployment controller 115 may deploy, based at least on the data object 230 (e.g., the JavaScript Object Notation (JSON) file) output by the cost engine 113, the first resource 135a from the first cloud provider 130a. For example, as shown in FIG. 3, the deployment controller 115 may receive, from the cost engine 113, on the data object 230 (e.g., the JavaScript Object Notation (JSON) file) including the cost estimate associated with the resource 135 and the recommendation to deploy the first resource 135a from the first cloud provider 130a. The deployment controller 115 may parse the data object 230, for example, the recommendation included in the data object 230, and retrieve a deployment template that is compatible with the first cloud provider 130a.

Moreover, the deployment controller 115 may generate a deployment template compatible with the first cloud provider 130a. For instance, as shown in FIG. 3, the deployment controller 115 may generate, one or more second templates 315 (e.g., TerraForm, Azure Resource Manager (ARM), YAML, and/or the like) compatible with the first cloud provider 130a. As noted, the one or more second templates 315 may replace the one or more first templates 210. Alternatively and/or additionally, the one or more second templates 315 may be generated by modifying the one or more first templates 210.

At 410, the selected resource may be deployed based on the second template. For example, the deployment controller 115 may deploy the first resource 135a by at least sending, to the first cloud provider 130a, a corresponding one of the second templates 315. In some example embodiments, the deployment controller 115 may initialize the deployment of the first resource 135a automatically or upon further request, for example, by a user at the client devices 120. For example, if the deployment is configured to be automatic (e.g., deployment based on cost), the deployment controller 115 may deploy the first resource 135a without requiring a corresponding request or command from the user at the client devices 120. Alternatively, if the deployment is not set to be automatic, the deployment controller 115 may initiate the deployment of the first resource 135a upon receiving, from the user at the client devices 120, a request or command to do so.

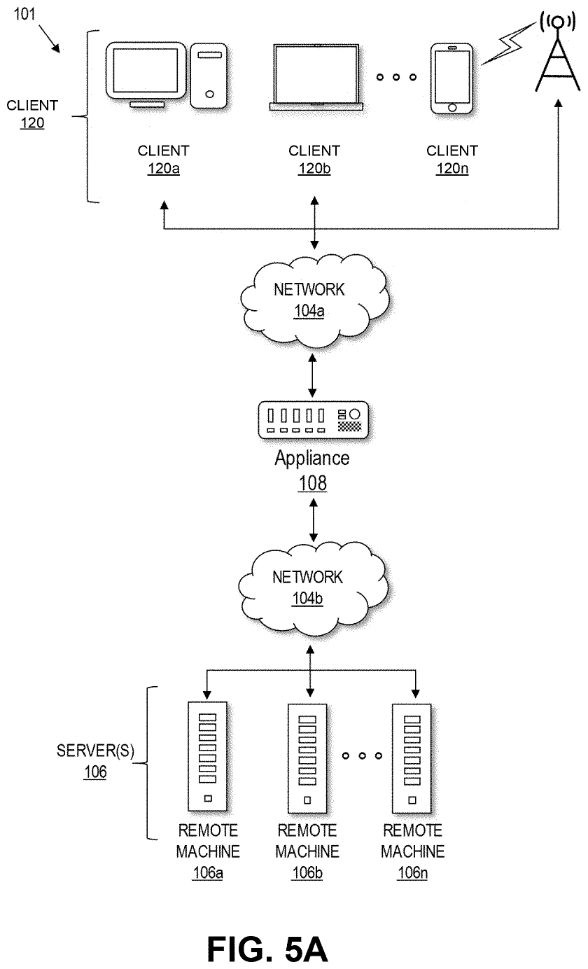

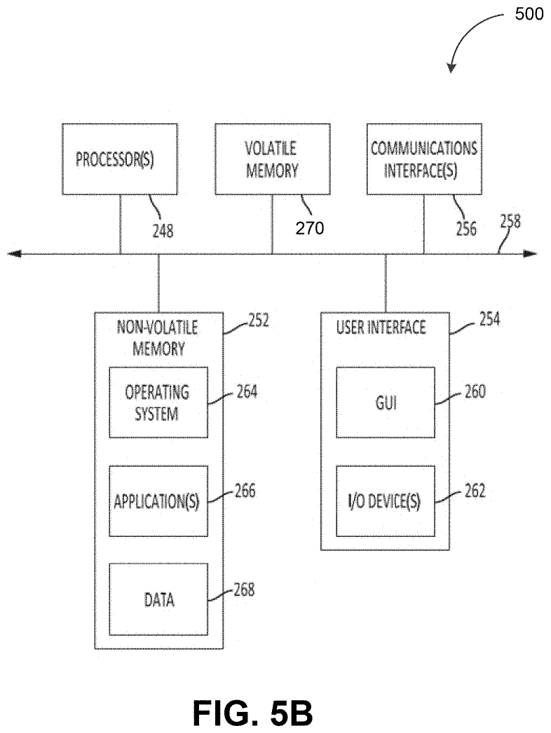

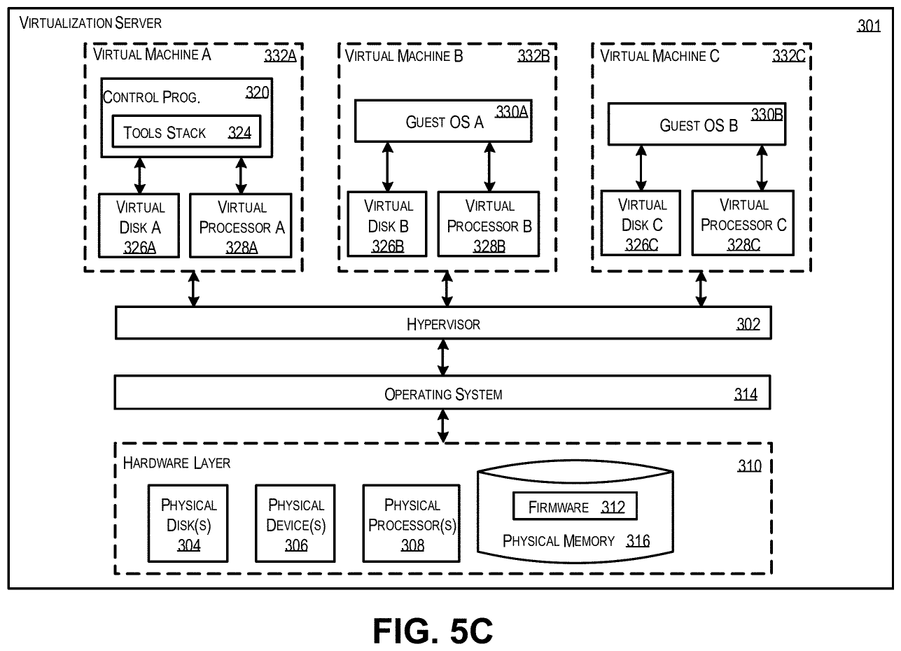

FIG. 5A depicts a network diagram illustrating an example of a network environment 101, in accordance with some example embodiments. Referring to FIGS. 1-4 and 5A, the network environment 101 in which various aspects of the disclosure may be implemented may include one or more client devices 120a-120n, one or more remote machines 106a-106n, one or more networks 104a and 104b, and one or more appliances 108 installed within the network environment 101. The client devices 120a-120n, communicate with the remote machines 106a-106n via the networks 104a and 104b.

In some example embodiments, the client devices 120a-120n may communicate with the remote machines 106a-106n via an appliance 108. The illustrated appliance 108 is positioned between the networks 104a and 104b, and may also be referred to as a network interface or gateway. In some example embodiments, the appliance 108 may operate as an application delivery controller (ADC) to provide clients with access to business applications and other data deployed in a datacenter, the cloud, or delivered as Software as a Service (SaaS) across a range of client devices, and/or provide other functionality such as load balancing and/or the like. In some example embodiments, multiple appliances 108 may be used, and the appliance(s) 108 may be deployed as part of the network 104a and/or 104b.

The client devices 120a-120n may be generally referred to as client machines, local machines, clients, client nodes, client computers, client devices, computing devices, endpoints, or endpoint nodes. The client devices 120a-120n may include, for example, the first client 110a, the second client 110b, and/or the like. The remote machines 106a-106n may be generally referred to as servers or a server farm. In some example embodiments, a client device 120 may have the capacity to function as both a client node seeking access to resources provided by a server 106 and as a server 106 providing access to hosted resources for other client devices 120a-120n. The networks 104a and 104b may be generally referred to as a network 104. The network 104 including the networks 104a and 104b may be configured in any combination of wired and wireless networks.

The servers 106 may include any server type of servers including, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality. The servers 106 may include, for example, the cost engine 113, the deployment controller 115 and/or the like.

A server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft internet protocol telephone; an application for streaming video and/or audio; an application for facilitating real-time-data communications; a hypertext transfer protocol (HTTP) client; a file transfer protocol (FTP) client; an Oscar client; a Telnet client; or any other set of executable instructions.

In some example embodiments, a server 106 may execute a remote presentation services program or other program that uses a thin-client or a remote-display protocol to capture display output generated by an application executing on a server 106 and transmit the application display output to a client device 120.

In yet other example embodiments, a server 106 may execute a virtual machine providing, to a user of a client device 120, access to a computing environment. The client device 120 may be a virtual machine. The virtual machine may be managed by, for example, a hypervisor, a virtual machine manager (VMM), or any other hardware virtualization technique within the server 106.

In some example embodiments, the network 104 may be a local-area network (LAN), a metropolitan area network (MAN), a wide area network (WAN), a primary public network, and/or a primary private network. Additional embodiments may include one or more mobile telephone networks that use various protocols to communicate among mobile devices. For short-range communications within a wireless local-area network (WLAN), the protocols may include 802.11, Bluetooth, and Near Field Communication (NFC).

FIG. 5B depicts a block diagram illustrating an example of a computing device 500, in accordance with some example embodiments. Referring to FIGS. 1-4 and 5A-B, the computing device 500 may be useful for practicing an embodiment of the cost engine 113, the deployment controller 115, the client devices 120, and/or the like.

As shown in FIG. 5B, the computing device 500 may include one or more processors 248, volatile memory 270 (e.g., RAM), non-volatile memory 252 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 254, one or more communications interfaces 256, and a communication bus 258. The user interface 254 may include a graphical user interface (GUI) 260 (e.g., a touchscreen, a display, and/or the like) and one or more input/output (I/O) devices 262 (e.g., a mouse, a keyboard, and/or the like). The non-volatile memory 252 may store an operating system 264, one or more applications 266, and data 268 such that computer instructions of the operating system 264 and/or applications 266 are executed by the processor(s) 248 out of the volatile memory 270. Data may be entered using an input device of the GUI 260 or received from I/O device(s) 262. Various elements of the computing device 500 may communicate via communication the communication bus 258. The computing device 500 as shown in FIG. 5B is shown merely as an example, as the cost engine 113, the deployment controller 115, and/or the client devices 120 may be implemented by any computing or processing environment and with any type of machine or set of machines that may have suitable hardware and/or software capable of operating as described herein.

The processor(s) 248 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some example embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some example embodiments, the “processor” may be one or more physical processors or one or more “virtual” (e.g., remotely located or “cloud”) processors.

The communications interfaces 256 may include one or more interfaces to enable the computing device 500 to access a computer network such as a local area network (LAN), a wide area network (WAN), a public land mobile network (PLMN), and/or the Internet through a variety of wired and/or wireless or cellular connections.

As noted above, in some example embodiments, one or more computing devices 500 may execute an application on behalf of a user of a client computing device (e.g., the client 120), may execute a virtual machine, which provides an execution session within which applications execute on behalf of a user or a client computing device (e.g., the client 120), such as a hosted desktop session, may execute a terminal services session to provide a hosted desktop environment, or may provide access to a computing environment including one or more of: one or more applications, one or more desktop applications, and one or more desktop sessions in which one or more applications may execute.

FIG. 5C depicts a high-level architecture of an example of a virtualization system for implementing the cloud computing system 100, in accordance with some example embodiments. As shown in FIG. 5C, the virtualization system may be a single-server or multi-server system, or a cloud system, including at least one virtualization server 301 configured to provide virtual desktops and/or virtual applications to one or more client access devices 120a-c. As used herein, a desktop may refer to a graphical environment (e.g., a graphical user interface) or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per physical device) or virtual (e.g., many instances of an OS running on a single physical device). Each application may be executed on a local device, or executed on a remotely located device (e.g., remoted).

Virtualization server 301 may be configured as a virtualization server in a virtualization environment, for example, a single-server, multi-server, or cloud computing environment. Virtualization server 301 illustrated in FIG. 5C may be deployed as and/or implemented by one or more embodiments of server 106 illustrated in FIG. 5A or by other known computing devices. Included in virtualization server 301 is hardware layer 310 that may include one or more physical disks 304, one or more physical devices 306, one or more physical processors 308, and one or more physical memories 316. In some embodiments, firmware 312 may be stored within a memory element in physical memory 316 and be executed by one or more of physical processors 308. Virtualization server 301 may further include operating system 314 that may be stored in a memory element in physical memory 316 and executed by one or more of physical processors 308. Still further, hypervisor 302 may be stored in a memory element in physical memory 316 and be executed by one or more of physical processors 308. Presence of operating system 314 may be optional such as in a case where the hypervisor 302 is a Type A hypervisor.

Executing on one or more of physical processors 308 may be one or more virtual machines 332A-C (generally 332). Each virtual machine 332 may have virtual disk 326A-C and virtual processor 328A-C. In some embodiments, first virtual machine 332A may execute, using virtual processor 328A, control program 320 that includes tools stack 324. Control program 320 may be referred to as a control virtual machine, Domain 0, Dom0, or other virtual machine used for system administration and/or control. In some embodiments, one or more virtual machines 332B-C may execute, using virtual processor 328B-C, guest operating system 330A-B (generally 330).

Physical devices 306 may include, for example, a network interface card, a video card, an input device (e.g., a keyboard, a mouse, a scanner, etc.), an output device (e.g., a monitor, a display device, speakers, a printer, etc.), a storage device (e.g., an optical drive), a Universal Serial Bus (USB) connection, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in hardware layer 310 may include any type of memory. Physical memory 316 may store data, and in some embodiments may store one or more programs, or set of executable instructions. FIG. 5C illustrates an embodiment where firmware 312 is stored within physical memory 316 of virtualization server 301. Programs or executable instructions stored in physical memory 316 may be executed by the one or more processors 308 of virtualization server 301.

Virtualization server 301 may also include hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 may be any combination of executable instructions and hardware that monitors virtual machines 332 executing on a computing machine. Hypervisor 302 may be a Type 2 hypervisor, where the hypervisor executes within operating system 314 executing on virtualization server 301. Virtual machines may then execute at a layer above hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on virtualization server 301 by directly accessing the hardware and resources within hardware layer 310. That is, while Type 2 hypervisor 302 accesses system resources through host operating system 314, as shown, a Type 1 hypervisor may directly access all system resources without host operating system 314. A Type 1 hypervisor may execute directly on one or more physical processors 308 of virtualization server 301, and may include program data stored in physical memory 316.

Hypervisor 302, in some embodiments, may provide virtual resources to guest operating systems 330 or control programs 320 executing on virtual machines 332 in any manner that simulates operating systems 330 or control programs 320 having direct access to system resources. System resources can include, but are not limited to, physical devices 306, physical disks 304, physical processors 308, physical memory 316, and any other component included in hardware layer 310 of virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for virtual machine 332 executing on virtualization server 301. Examples of hypervisor 302 may include those manufactured by VMWare, Inc., of Palo Alto, Calif.; Xen Project® hypervisor, an open source product whose development is overseen by the open source XenProject.org community; Hyper-V®, Virtual Server®, and Virtual PC® hypervisors provided by Microsoft Corporation of Redmond, Wash.; or others. The virtualization server 301 may execute hypervisor 302 that creates a virtual machine platform on which guest operating systems 330 may execute. When this is the case, virtualization server 301 may be referred to as a host server. An example of such a virtualization server is Citrix Hypervisor® provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create virtual machine 332. The virtual machine image may refer to a collection of data, states, instructions, etc. that make up an instance of a virtual machine. In other embodiments, hypervisor 302 may execute guest operating system 330 within virtual machine 332. In still other embodiments, virtual machine 332 may execute guest operating system 330.

In addition to creating virtual machines 332, hypervisor 302 may control the execution of at least one virtual machine 332. The hypervisor 302 may present at least one virtual machine 332 with an abstraction of at least one hardware resource provided by virtualization server 301 (e.g., any hardware resource available within hardware layer 310). In some implementations, hypervisor 302 may control the manner in which virtual machines 332 access physical processors 308 available in virtualization server 301. Controlling access to physical processors 308 may include determining whether virtual machine 332 should have access to processor 308, and how physical processor capabilities are presented to virtual machine 332.

As shown in FIG. 5C, the virtualization server 301 may host or execute one or more virtual machines 332. Virtual machine 332 may be a set of executable instructions and/or user data that, when executed by processor 308, may imitate the operation of a physical computer such that virtual machine 332 can execute programs and processes much like a physical computing device. While FIG. 5C illustrates an embodiment where virtualization server 301 hosts three virtual machines 332, in other embodiments virtualization server 301 may host any number of virtual machines 332. Hypervisor 302 may provide each virtual machine 332 with a unique virtual view of the physical hardware, including memory 316, processor 308, and other system resources 304, 306 available to that virtual machine 332. The unique virtual view may be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to virtual machines 332.

Each virtual machine 332 may include virtual disk 326A-C (generally 326) and virtual processor 328A-C (generally 328.) Virtual disk 326 may be a virtualized view of one or more physical disks 304 of virtualization server 301, or a portion of one or more physical disks 304 of virtualization server 301. The virtualized view of physical disks 304 may be generated, provided, and managed by hypervisor 302. In some embodiments, hypervisor 302 may provide each virtual machine 332 with a unique view of physical disks 304. These particular virtual disks 326 (included in each virtual machine 332) may be unique, when compared with other virtual disks 326.

Virtual processor 328 may be a virtualized view of one or more physical processors 308 of virtualization server 301. The virtualized view of physical processors 308 may be generated, provided, and managed by hypervisor 302. Virtual processor 328 may have substantially all of the same characteristics of at least one physical processor 308. Virtual processor 308 may provide a modified view of physical processors 308 such that at least some of the characteristics of virtual processor 328 are different from the characteristics of the corresponding physical processor 308.

One or more aspects or features of the subject matter described herein can be realized in digital electronic circuitry, integrated circuitry, specially designed application-specific integrated circuitry (ASIC), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one data processor; and
at least one memory storing instructions, which when executed by the at least one data processor, cause the at least one data processor to at least:
receive a first template specifying a cloud resource requirement;
identify a first resource from a first cloud provider and a second resource from a second cloud provider, the first resource and the second resource being a same or comparable resource capable of satisfying the cloud resource requirement specified by the first template;
select, based at least on a respective cost associated with the first resource and the second resource, the first resource instead of the second resource;
generate a second template for deploying the first resource at the first cloud provider; and
deploy the first resource by at least sending, to the first cloud provider, the second template.

2. The system of claim 1, wherein the generating of the second template includes modifying the first template or replacing the first template with the second template.

3. The system of claim 1, wherein the first template and/or the second template comprise a TerraForm template, an Azure Resource Manager (ARM) template, a YAML template, and/or a custom template.

4. The system of claim 1, wherein the first template and/or the second template include one or more JavaScript Object Notation (JSON) files.

5. The system of claim 1, wherein the first resource is selected instead of the second resource based at least on a first cost of the first resource being lower than a second cost of the second resource.

6. The system of claim 1, wherein the executing of the instructions further causes the at least one data processor to at least:
generate a data object including one or more specifications, settings, and/or parameters associated with the first resource; and
generate, based at least on the data object, the second template.

7. The system of claim 1, wherein the first resource and the second resource are identified based at least on a mapping of comparable resources available from a plurality of cloud providers.

8. The system of claim 1, wherein the executing of the instructions further causes the at least one data processor to at least:
convert the first template into a markup language file; and
identify, based at least on the markup language file, the first resource and the second resource as satisfying the cloud resource requirement.

9. The system of claim 8, wherein the markup language file specifies a quantity of required virtual machines, a size of storage, a virtual machine processing capability, and/or a deployed geographic region.

10. The system of claim 1, wherein the first resource and/or the second resource include a virtual machine, a storage account, a web application, a database, and/or a virtual network.

11. The system of claim 1, wherein the first cloud provider and/or the second cloud provider include an infrastructure as a service (IaaS) platform configured to provide one or more application programming interfaces and pools of hypervisors including virtual machines, and wherein the one or more application programming interfaces enable a provisioning of processing, storage, and/or networks to support an operating system and/or an application.

12. A computer-implemented method, comprising:
receiving a first template specifying a cloud resource requirement;
identifying a first resource from a first cloud provider and a second resource from a second cloud provider, the first resource and the second resource being a same or comparable resource capable of satisfying the cloud resource requirement specified by the first template;
selecting, based at least on a respective cost associated with the first resource and the second resource, the first resource instead of the second resource;
generating a second template for deploying the first resource at the first cloud provider; and
deploying the first resource by at least sending, to the first cloud provider, the second template.

13. The method of claim 12, wherein the generating of the second template includes modifying the first template or replacing the first template with the second template.

14. The method of claim 12, wherein the first template and/or the second template comprise a TerraForm template, an Azure Resource Manager (ARM) template, a YAML template, and/or a custom template.

15. The method of claim 12, wherein the first template and/or the second template include one or more JavaScript Object Notation (JSON) files.

16. The method of claim 12, wherein the first resource is selected instead of the second resource based at least on a first cost of the first resource being lower than a second cost of the second resource.

17. The method of claim 12, further comprising:
generating a data object including one or more specifications, settings, and/or parameters associated with the first resource; and
generating, based at least on the data object, the second template.

18. The method of claim 12, wherein the first resource and the second resource are identified based at least on a mapping of comparable resources available from a plurality of cloud providers.

19. The method of claim 12, further comprising:
converting the first template into a markup language file; and
identifying, based at least on the markup language file, the first resource and the second resource as satisfying the cloud resource requirement, the markup language file specifying a quantity of required virtual machines, a size of storage, a virtual machine processing capability, and/or a deployed geographic region.

20. A non-transitory computer readable medium storing instructions, which when executed by at least one data processor, result in operations comprising:
receiving a first template specifying a cloud resource requirement;
identifying a first resource from a first cloud provider and a second resource from a second cloud provider, the first resource and the second resource being a same or comparable resource capable of satisfying the cloud resource requirement specified by the first template;
selecting, based at least on a respective cost associated with the first resource and the second resource, the first resource instead of the second resource;
generating a second template for deploying the first resource at the first cloud provider; and
deploying the first resource by at least sending, to the first cloud provider, the second template.
